(19) United States
(12) Patent Application Publication
(10) Pub. No.: US 2007/0260992 A1
(43) Pub. Date: Nov. 8, 2007

(54) Graphical procedure development environment

(75) Inventor: John R. Hajdukiewicz, Cambridge, MA (US)

Correspondence Address: Anthony Miologos;Honeywell International Inc., 101 Columbia Rd., P.O. Box 2245, Morristown, NJ, 07962, US

(73) Assignee: Honeywell International Inc.

(21) Appl. No.: 11/429,530

(22) Filed: May 4, 2006

(51) Int. Cl. G06F 3/00

(52) U.S. Cl. 715/762

(57) ABSTRACT

A method, system and program product for graphically developing a procedure. A plurality of procedure elements can be displayed in a first section of a graphical user interface. One or more procedure elements can be selected from among the plurality of procedure elements for manipulation in a second section of the graphical user interface in order to modularize the procedure elements, in response to a user selection of one or more procedure element via the graphical user interface. A procedure can then be created by manipulating one or more procedure element via the second section of the graphical user interface, thereby promoting a consistency in the configuration, development and modification of the procedure.

### TECHNICAL FIELD

Embodiments are generally related to data-processing systems and methods. Embodiments are also related to procedure and workflow processing and operations. Embodiments are additionally related to graphical user interface (GUI) environments.

### BACKGROUND

The ability to review and implement procedures is an important part of design, engineering and production in industrial, commercial and consumer environments. Lifecycle management, for example, impacts the performance of procedural operations. Current procedural development practices are error prone and take a significant amount of time and resources.

New procedural support technologies, such as procedural automation and mobile devices, are being introduced to improve procedural operations. In addition, such technologies can provide benefits by supporting the post-execution analysis of procedures. Such technologies, however, can compound the problem of procedure lifecycle management. A concern is that an operations team may need to update multiple procedures for each delivery platform when procedural changes are required. Such an approach can result in entry errors and the need for personnel to manage and update duplicate procedures. In addition, compliance with regulatory requirements is a challenge unmet by current procedural support technologies.

Procedure lifecycle management is a key challenge for industry. Operations teams must deal with a number of pressures and issues. First, the workload of operators is constantly increasing; there is very little time to adequately modify and review procedures. Second, there are fewer resources and key resources are not usually available for procedure management. Third, procedure lifecycle management and management of change (MOC) processes are typically time consuming. Fourth, expectations may not be clear in terms of roles and responsibilities.

As new technologies are developed for procedure execution, a number of challenges need to be addressed. A number of outstanding issues in procedure lifecycle management remain to be solved. Procedures are currently primarily created using text based applications, such as Word. It is difficult or cumbersome to reuse similar procedure elements, see the overall structure of the procedure, and end up with a consistent coding scheme. Additionally, it is difficult and takes a great deal of effort to maintain procedures up to date and accurate. It is also not clear how a site can track progress as procedures are modified and/or created. There are typically too many procedures to manage at a site. Procedure content is also typically not consistent in the level of detail and format used at a site. In industrial processes, for example, procedures can change frequently. A need exists for a system and method to keep up with such changes and to ensure that procedural changes are not missed.

### BRIEF SUMMARY

The following summary is provided to facilitate an understanding of some of the innovative features unique to the embodiments and is not intended to be a full description. A full appreciation of the various aspects of the embodiments disclosed can be gained by taking the entire specification, claims, drawings, and abstract as a whole.

It is, therefore, one aspect of the present invention to provide for improved data-processing systems and methods.

It is yet another aspect of the present invention to provide for an improved method and system for creating procedures.

It is a further aspect of the present invention to provide for a method and system for graphically developing procedures in a graphical procedure environment.

The aforementioned aspects of the invention and other objectives and advantages can now be achieved as described herein. A method, system and program product for graphically developing a procedure is disclosed. A plurality of procedure elements can be displayed in a first section of a graphical user interface (GUI). One or more procedure elements can be selected from among the plurality of procedure elements for manipulation in a second section of the graphical user interface in order to modularize the procedure elements, in response to a user selection of one or more procedure element via the graphical user interface or another format, such as, for example, a non-GUI textual format. A procedure can then be created by manipulating one or more procedure element via the second section of the graphical user interface, thereby promoting a consistency in the configuration, development and modification of the procedure.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a block diagram of a computer system, which can be adapted for use in implementing a preferred embodiment;

FIG. 2 illustrates a block diagram of a flow chart of operations illustrating logical operational steps for identifying procedures for automation and appropriate degrees of lifecycle management, in accordance with a preferred embodiment;

FIG. 3 illustrates a system for procedure classification, which can be implemented in accordance with an embodiment;

FIG. 4 illustrates a graphical procedure development system, which can be implemented in accordance with an embodiment;

FIG. 5 illustrates an example reporting graph that can be generated and displayed utilizing the system depicted in FIG. 4, in accordance with an embodiment; and

FIG. 6 illustrates a high-level flow chart of operations depicting logical operational steps for implementing a method for graphically developing a procedure, in accordance with an embodiment.

### DETAILED DESCRIPTION

The particular values and configurations discussed in these non-limiting examples can be varied and are cited merely to illustrate at least one embodiment and are not intended to limit the scope of the invention.

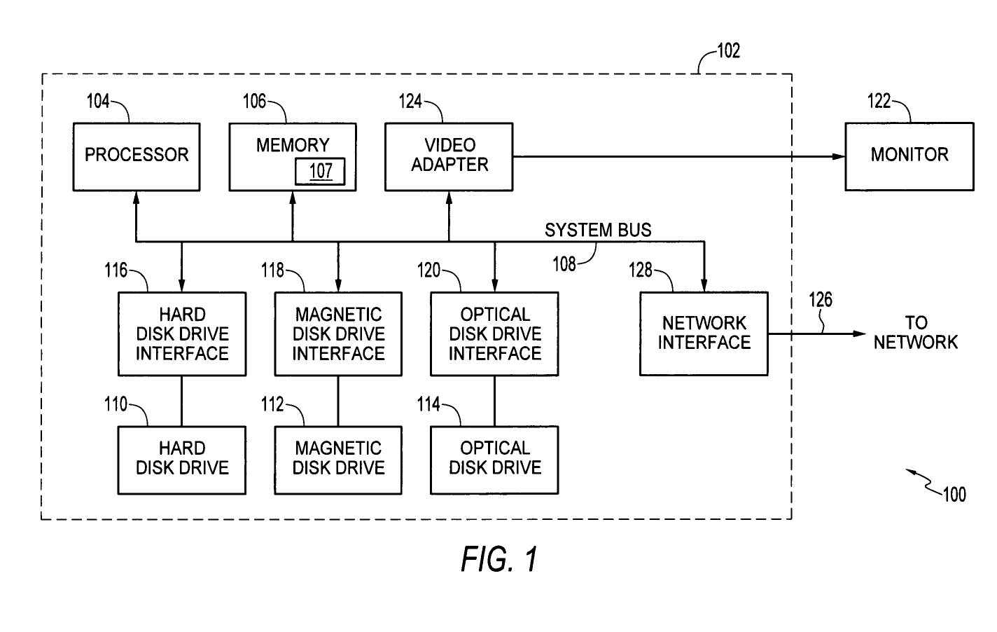

FIG. 1 illustrates a block diagram of a data-processing apparatus 100, which can be utilized to implement a preferred embodiment. Data-processing apparatus 100 can to implement a graphical procedure development environment as described in greater detail herein. Data-processing apparatus 100 can be configured to include a general purpose computing device, such as a computer 102. The computer 102 includes a processing unit 104, a memory 106, and a system bus 108 that operatively couples the various system components to the processing unit 104. One or more processing units 104 operate as either a single central processing unit (CPU) or a parallel processing environment.

The data-processing apparatus 100 further includes one or more data storage devices for storing and reading program and other data. Examples of such data storage devices include a hard disk drive 110 for reading from and writing to a hard disk (not shown), a magnetic disk drive 112 for reading from or writing to a removable magnetic disk (not shown), and an optical disc drive 114 for reading from or writing to a removable optical disc (not shown), such as a CD-ROM or other optical medium. A monitor 122 is connected to the system bus 108 through an adapter 124 or other interface. Additionally, the data-processing apparatus 100 can include other peripheral output devices (not shown), such as speakers and printers.

The hard disk drive 110, magnetic disk drive 112, and optical disc drive 114 are connected to the system bus 108 by a hard disk drive interface 116, a magnetic disk drive interface 118, and an optical disc drive interface 120, respectively. These drives and their associated computer-readable media provide nonvolatile storage of computer-readable instructions, data structures, program modules, and other data for use by the data-processing apparatus 100. Note that such computer-readable instructions, data structures, program modules, and other data can be implemented as a module or group of modules, such as, for example, module 107.

Note that the embodiments disclosed herein can be implemented in the context of a host operating system and one or more module(s) 107. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 100, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used in connection with the embodiments.

A number of program modules can be stored or encoded in a machine readable medium such as the hard disk drive 110, the, magnetic disk drive 114, the optical disc drive 114, ROM, RAM, etc or an electrical signal such as an electronic data stream received through a communications channel. These program modules can include an operating system, one or more application programs, other program modules, and program data.

The data-processing apparatus 100 can operate in a networked environment using logical connections to one or more remote computers (not shown). These logical connections are implemented using a communication device coupled to or integral with the data-processing apparatus 100. The data sequence to be analyzed can reside on a remote computer in the networked environment. The remote computer can be another computer, a server, a router, a network PC, a client, or a peer device or other common network node. FIG. 1 depicts the logical connection as a network connection 126 interfacing with the data-processing apparatus 100 through a network interface 128. Such networking environments are commonplace in office networks, enterprise-wide computer networks, intranets, and the Internet, which are all types of networks. It will be appreciated by those skilled in the art that the network connections shown are provided by way of example and that other means of and communications devices for establishing a communications link between the computers can be used.

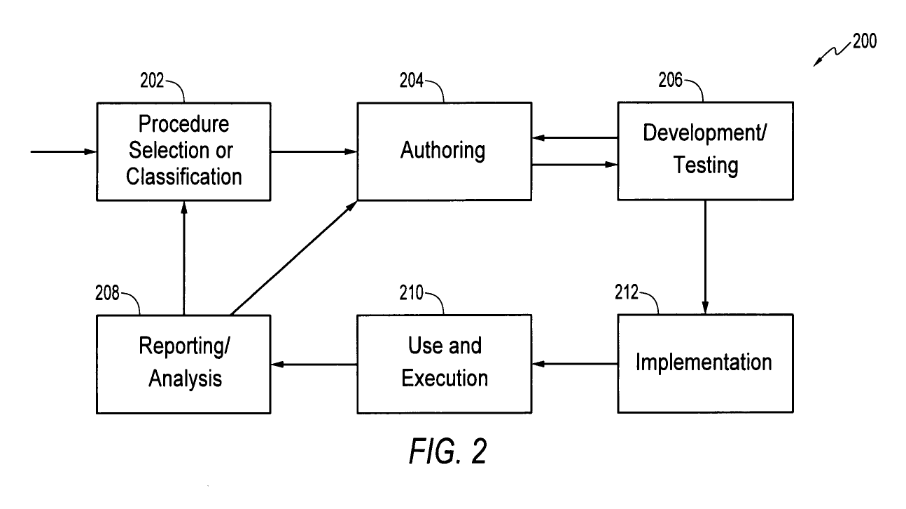

FIG. 2 illustrates a block diagram of a flow chart 200 of operations illustrating a general lifecycle process, which can be implemented in accordance with a preferred embodiment. Flow chart 200 implements a lifecycle process based on defined metrics that can be measured throughout the process. Reporting and analysis generally focus on procedure quality and efficiency. Other tasks include monitoring how well the lifecycle process is functioning. Additional reporting and analysis operations can be available for automated procedures. In general, a procedure selection or classification is illustrated as depicted at block 202.

Thereafter, as indicated at block 204, an authoring operation can be implemented, followed by a development and/or testing operation as indicated at block 206. Note that the results of the operation depicted at block 206 can also be provided as input to the authoring operation illustrated at block 204. As illustrated at block 212, implementation of the developed and tested procedure can occur, following by the operation depicted at block 210, involving actually use and implementation of the developed procedure. Following process of the operation depicted at block 210, a reporting and analysis function can be implemented, as indicated at block 212. Resulting data can then be provided to either or one of the operations depicted at blocks 202, 204.

Numerous stakeholders are found in a procedure lifecycle management system. Each role has different concerns and needs. For example, an area superintendent may be required to maintain procedures up to date, and available to operators. An operator may be required, who is a user that triggers changes, reviews procedures, deviates from procedures and redlines procedures. A PSM may be responsible for ensuring that all procedures are kept up to date, while also providing the “big picture” view of the procedures, along with maintaining records, conducting procedure training, and also providing reviews.

Two options are generally required for reviewing procedures. First, an online documentation and review process is desirable, along with the ability to export to PDF/paper for collaborative review and enter/scan later to a system. To accommodate the different roles, a number of “views” to the procedure management system are useful. For example, high level graphics and drill down modules that provide the overall status, including the percentage completed, an indication the regulatory requirements have been met, along with data concerning who is currently working with a procedure, in addition to a user's status and workload. It is also desirable to graphically provide an individual person view, which includes a “to do” list, status, training tracker, and loading information. Additionally, a “procedure view” is desirable that includes training information, access to procedures, the status of review, who has access to a current procedure, who has “signed off” and so forth.

A procedure selection task for tracking and categorizing procedures for automation can be implemented. First, a business case should be preferably developed for procedure automation, which can involve developing an impact matrix (i.e., dimensions of environment, safety, incidents, HazOps, operator loading/manpower, etc.). Such a matrix can help identify high impact transitions, events, procedures, and frequency of use. Such a matrix can also be utilized to assess feasibility and preliminary cost estimates.

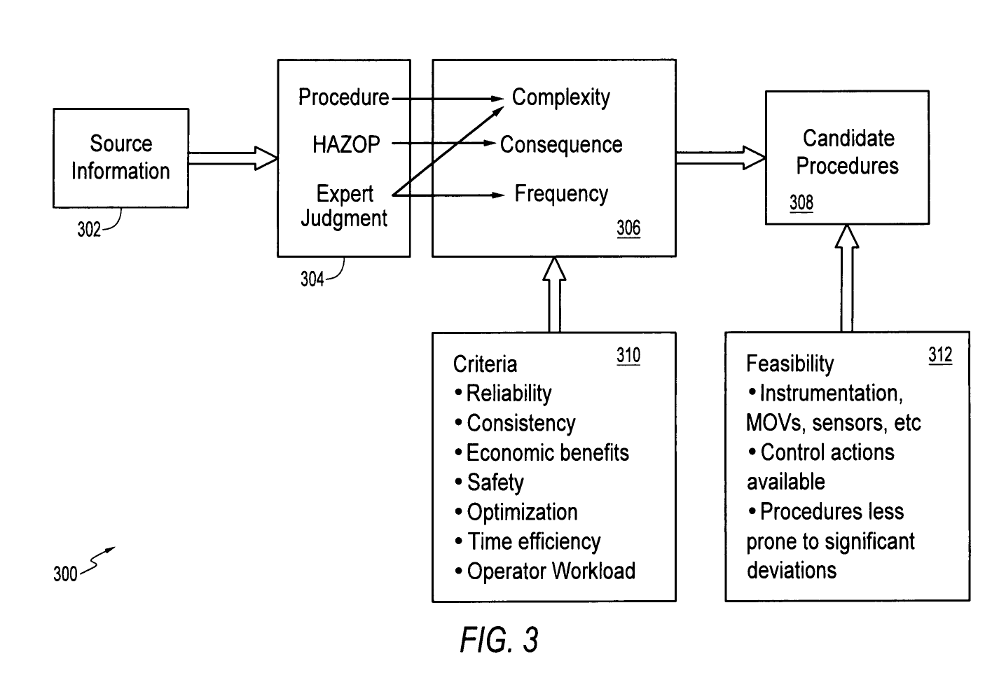

A procedure classification framework can be implemented to help identify procedures for automation and appropriate degrees of lifecycle management. FIG. 3 illustrates a system 300 for procedure classification, which can be implemented in accordance with a preferred embodiment. System 300 depicted in FIG. 3 generally includes a block 302, which represents source information, which can be input to a matrix, which is illustrated by blocks 304 and 306. Block 304 generally depicts procedure, HAZOP, and expert judgment functionality data, which is interlinked with complexity, consequence and frequency parameters as illustrated in block 306. Output generated as a result of the matrix operations depicted in blocks 304, 306 can be provided as input data to a candidate procedures operation as illustrated at block 308. Block 310 generally represents a criteria operation and/or functionality, the results of which can be input as data the operation illustrated at block 306. Similarly, block 312 illustrates a feasibility operation and/or functionality, the results of which can be input as data to the operation illustrated at block 308.

In general, users can be graphically provided with an SOP library that includes a set of procedure candidates for modification or automation. Procedures can then be imported with automatic classification. Such procedures can be generated to include links to the impact matrix indicated at blocks 304, 306, and automatically populated based on incidents, HAZOPs, etc. Users can manually readjust classifications as needed. When selecting potential procedures to automate, users can be presented with a list of automation candidates, which may be scored in 3 dimensions, based on business case, feasibility, cost. Thresholds can then be set based on automatic recommendation and resources availability.

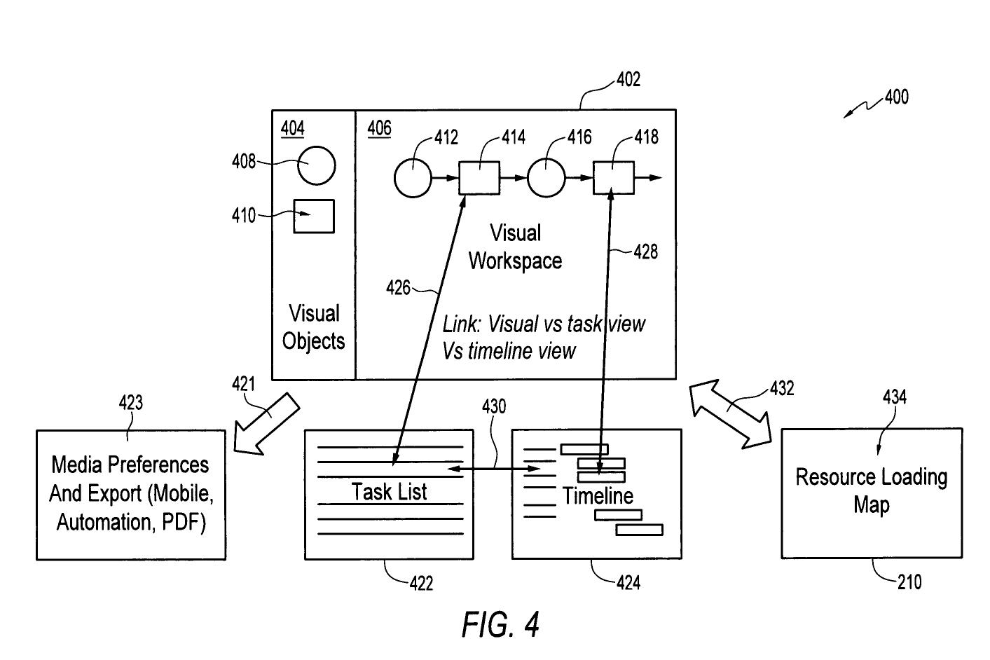

FIG. 4 illustrates a graphical procedure development system 400, which can be implemented in accordance with a preferred embodiment. System 400 can be provided in the context of a graphically displayed “procedure studio” constituting an integrated graphical work environment for procedure creation, configuration, sequencing, dependencies, timing, formatting, and resource loading and analysis (e.g., geographic analysis on workload, coordination requirements). Media export can be made available for mobile, console displays, PDF optimization of formats and interaction, and preferences on which fields appear in media options.

FIG. 4 illustrates shows the general environment of reusable objects, projects, templates. Drag and drop functionality is available for task steps (visual objects and text features). Users are also able to comment. More advanced features can include procedure optimization and plan loading, constraint-based reasoning, and machine learning from scenario simulation and previous executions.

System 400 generally includes a graphical user interface (GUI) 402 that includes two GUI sections 404 and 406. As utilized herein, a GUI can be provided as a graphical environment that represents programs, files, and options utilizing graphically displayed devices such as icons, menus, dropdown menus, dialog boxes and so forth. A user can select and activate these options by pointing and clicking with a pointing device such as a mouse and/or keyboard, which provide user input to a data-processing apparatus, such as, for example, the data-processing apparatus 100 depicted in FIG. 1. A particular item, such as, for example, a scroll bar, generally functions the same with different applications, because the GUI 402 provides standard software routines or modules to handle such elements and track the user's actions. GUI 402 and hence, system 400, can be provided in the context of a module or group of modules, such as module 107 depicted in FIG. 1, depending upon design considerations.

GUI section 404 generally functions as an area for graphically displaying visual objects, such as, for example, visual objects 408 and 410. GUI section 406 can be provided as a visual workspace in which objects 412, 414, 416, and 418 can be displayed. Object 418 can function as, for example, a graphically displayed object that when selected, provides a user with access to procedure details, configurations, dependencies and/or resource requirements. GUI section 404 can function as a graphically displayed side bar that allows procedure elements (e.g., objects 408, 410) to be dragged from the sidebar or GUI section 404. System 400 allows procedure elements and tasks to be modularized and re-used in order to promote consistency in procedure development and modification.

Arrow 428 indicates by way of example that when object 418 is selected by a user, a timeline can be generated as indicated by block 424, which displays via GUI 402 timeline data and displays manual information, user and procedural roles, and so forth. Similarly, when object 414 is selected by a user, as indicated by arrow 426, a task list can be generated and displayed for a user via GUI 402 as depicted by block 422, which displays tasks, roles, sequences and the like. Arrows 426, 428 and 430 illustrated in FIG. 4 generally indicate a link between the visual views provided by GUI sections 404, 406 versus the task view illustrated by block 422 and the timeline view depicted at block 424.

Arrow 421 depicted in FIG. 4 indicates that the results of the GUI operations implemented via the GUI 402 can be rendered in the form of various media formats, such as PDF, and/or other exported formats as depicted at block 423. Block 434 depicted in FIG. 4 indicates that resource loading map operations can be generated and modified. Arrow 432 illustrates the link between GUI 402 and the operations depicted at block 434. A resource loading map function as depicted at block 434 can result in the generation of, for example, geographic maps, resource requirements and other procedural capabilities.

Procedure reporting and analysis provide an operations team with critical feedback on procedure performance that is useful in lifecycle management. A number of features may be useful for display and comparison using the GUI system 400 depicted in FIG. 4. Such features, can include, for example, comparison with good/golden procedure, critical variable versus time, trajectory data, events versus time, activities vs. time, online-redline capabilities, prompted or unprompted deviations, comments, composite ratings (e.g., incidents, OK or not), cost, objectives, projections, authorization of deviations, real-time trends compared with previous histories (i.e., best one or others), and so forth.

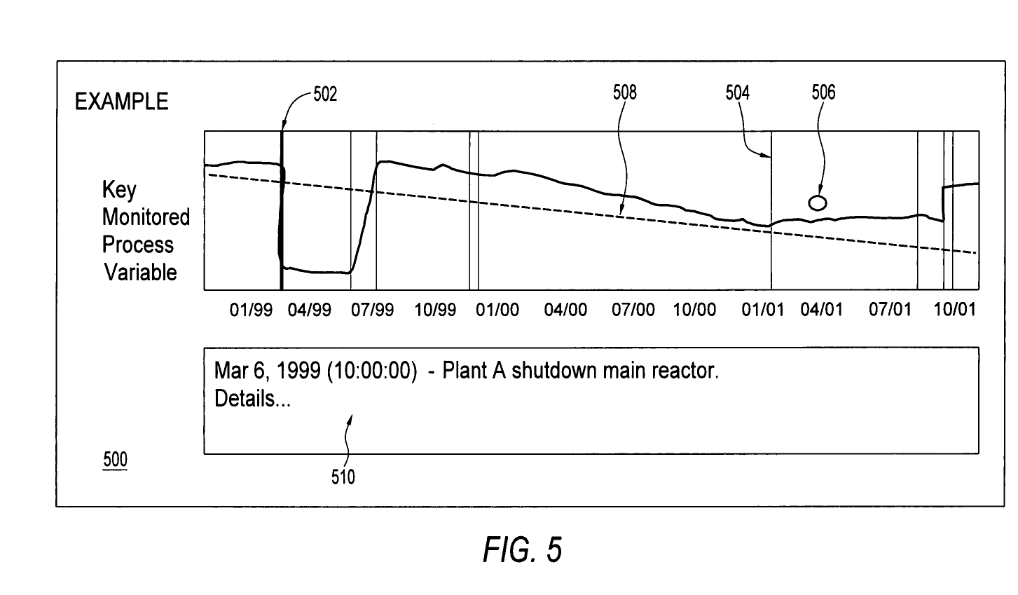

FIG. 5 illustrates an example reporting graph 500 that can be generated and displayed utilizing system 400 depicted in FIG. 4, in accordance with a preferred embodiment. Graph 500 generally illustrates various types of information that can be plotted and compared for future reference when modifying/maintaining procedures. Other features that can be incorporated include: visual query, machine learning, pattern matching, and early event detection for procedures. In the example graph 500, a GUI cursor 502 can be utilized to select log entry data, while a line 504 indicates a log/message item relevant to the process variable noted on trend for that particular time. A graphical dot 506 indicates a logged critical event or alarm. Symbols such as the graphical dot 506 can indicate event activity, alarms, etc. at a point in time. A graphically displayed area 510 can provide log/message entry and details, while a line 508 indicates the ideal procedure trajectory for critical details. FIG. 5 thus illustrates an example of procedure reporting results that can be useful for procedure modification and maintenance.

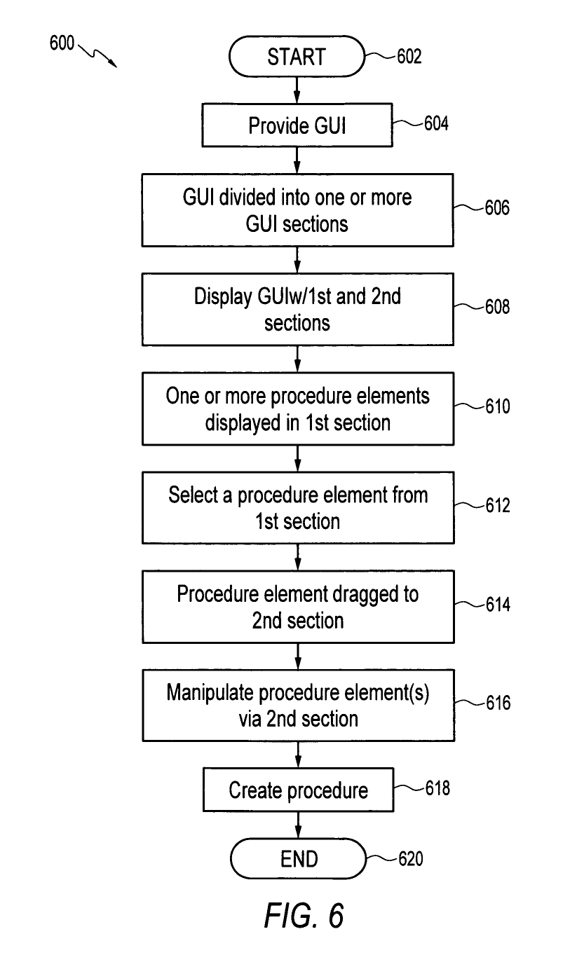

FIG. 6 illustrates a high-level flow chart 600 of operations depicting logical operational steps for implementing a method for graphically developing a procedure, in accordance with a preferred embodiment. As indicated at block 602, the process is initiated. Thereafter, as depicted at block 604, a graphical user interface (GUI) such as GUI 402 can be provided. Next, as indicated at block 606, the GUI is divided one or more GUI sections, such as, for example, the respective first and second GUI sections 404 and 406 discussed earlier. Next, as indicated at block 606, the first and second GUI sections 404 and 406 are displayed. Thereafter, as described at block 610, one or more procedure elements (e.g., procedure elements 408, 410) can be displayed in the 1^{st} GUI section 404.

Note that when displayed in the 1^{st} GUI section 404, the elements 408, 410 can constitute sidebar elements. Next, as indicated at block 612, a user can select one or more of the elements displayed in the 1^{st} GUI section and then drag such elements into the second GUI section 406, as indicated at block 614. By moving the elements into the 2^{nd} GUI section 406, the GUI 402 permits the procedure elements to be modularized, in response to a user selection of the procedure elements for manipulation as depicted at block 616 in order to create a procedure, as depicted at block 618. The process can then terminate, as indicated at block 620.

The method depicted in FIG. 6 can be implemented to overcome the problems with creating procedures utilizing text based applications, such as Word. As indicated previously, it is difficult or cumbersome to reuse similar procedure elements, see the overall structure of the procedure, and provide a consistent coding scheme during procedure creation and configuration. The method of flow chart 600 depicted in FIG. 6, on the other hand, provides a graphical environment (e.g., system 400) for creating procedures and understanding the interrelations of steps. Pre and post conditions, links, other documents, and other procedure-related information can be entered in a graphical format. Procedure elements can be dragged from sidebar elements (e.g., elements 408, 410) Procedure elements and tasks can be then modularized and reused to promote consistency in procedure development and modification.

Based on the foregoing, it can be appreciated that a number of key features can be implemented via the embodiments disclosed herein. For example, these key features are graphical procedure creation, procedure lifecycle management, procedure selection and reporting and analysis features.

A general lifecycle process can be implemented, which is static or automated. Metrics can be measured throughout the process. Reporting and analysis preferably focuses on procedure quality and efficiency. Other tasks include the ability to monitor how well a particular lifecycle process is functioning. Additional features in reporting and analysis can be available for automated procedures.

The key solution areas provided by the embodiments are thus as follows. First, “Procedure Lifecycle Management” involves presenting a number of “views” to a procedure management system that are useful for different stakeholders. For example, an Overall Status View (high level graphics and drill down), Individual Person View (1 page), Procedure View (1 page overview) and possible views. Second, “Procedure Selection” involves the ability to initially develop a business case for procedure automation. Such an ability can include the development of an impact matrix (e.g., dimensions of environment, safety, incidents, HazOps, operator loading/manpower, etc.). Such a matrix can assist in identifying high impact transitions, events, procedures, and frequency of use. Such a matrix can also assess feasibility and preliminary cost estimates.

Third, the “Procedure Studio” can be provided as an integrated graphical work environment for procedure creation, configuration, sequencing, dependencies, timing, formatting, and resource loading and analysis (e.g., geographic analysis on workload, coordination requirements). Media export can also be available for mobile, console displays, PDF optimization of formats and interaction, and preferences on which fields appear in media options. Fourth, and finally, “Reporting and Analysis” modules can be provided, which are utilized to provide an operations team with critical feedback regarding procedure performance that is useful in lifecycle management.

The embodiments can be implemented in the context of a method, system and/or program product depending upon design goals and considerations. In the context of a system, for example, one possible embodiment involves a computer implemented system for graphically developing a procedure, comprising, which includes the use of data-processing apparatus, such as apparatus 100 depicted in FIG. 1 in association with one or software modules, such as module 107 also depicted in FIG. 1. The module 107 can be executed by the data-process apparatus 100 and are operable in combination with one another to display a plurality of procedure elements in a first section of a graphical user interface, select one or more procedure elements from among the plurality of procedure elements for manipulation in a second section of the graphical user interface in order to modularize the plurality of procedure elements, in response to a user selection of one or more of the procedure elements via the graphical user interface, and create a procedure by manipulating one or more of the procedure elements via the second section of the graphical user interface, thereby promoting a consistency in the configuration, development and modification of the procedure.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer implemented method for graphically developing a procedure, comprising:
displaying a plurality of procedure elements in a first section of a graphical user interface; and
selecting at least one procedure element among said plurality of procedure elements for manipulation in a second section of said graphical user interface in order to modularize said plurality of procedure elements, in response to a user selection of said at least one procedure element via said graphical user interface; and
creating a procedure by manipulating said at least one procedure element via said second section of said graphical user interface, thereby promoting a consistency in the configuration, development and modification of said procedure.

2. The method of claim 1 further comprising graphically dragging said at least one procedure element from said first section to said second section of said graphical user interface, in response to selecting said at least one procedure element among said plurality of procedure elements.

3. The method of claim 1 further comprising generating sequencing data associated with said procedure by manipulating said at least one procedure element via said second section of said graphical user interface.

4. The method of claim 1 further comprising generating dependency data associated with said procedure by manipulating said at least one procedure element via said second section of said graphical user interface.

5. The method of claim 1 further comprising generating timing data associated with said procedure by manipulating said at least one procedure element via said second section of said graphical user interface.

6. The method of claim 1 further comprising generating analysis data associated with said procedure by manipulating said at least one procedure element via said second section of said graphical user interface.

7. The method of claim 1 further comprising rendering media associated with said procedure, in response to manipulating said at least one procedure element via said second section of said graphical user interface.

8. A computer implemented system for graphically developing a procedure, comprising:
a data-processing apparatus;
a module executed by said data-processing apparatus, said module and said data-processing apparatus being operable in combination with one another to:
display a plurality of procedure elements in a first section of a graphical user interface; and
select at least one procedure element among said plurality of procedure elements for manipulation in a second section of said graphical user interface in order to modularize said plurality of procedure elements, in response to a user selection of said at least one procedure element via said graphical user interface; and
create a procedure by manipulating said at least one procedure element via said second section of said graphical user interface, thereby promoting a consistency in the configuration, development and modification of said procedure.

9. The system of claim 8 wherein said data-processing apparatus and said module are further operable in combination with one another to graphically drag said at least one procedure element from said first section to said second section of said graphical user interface, in response to selecting said at least one procedure element among said plurality of procedure elements.

10. The system of claim 8 wherein said data-processing apparatus and said module are further operable in combination with one another to generate sequencing data associated with said procedure by manipulating said at least one procedure element via said second section of said graphical user interface.

11. The system of claim 8 wherein said data-processing apparatus and said module are further operable in combination with one another to generate dependency data associated with said procedure by manipulating said at least one procedure element via said second section of said graphical user interface.

12. The system of claim 8 wherein said data-processing apparatus and said module are further operable in combination with one another to generate timing data associated with said procedure by manipulating said at least one procedure element via said second section of said graphical user interface.

13. The system of claim 8 wherein said data-processing apparatus and said module are further operable in combination with one another to generate analysis data associated with said procedure by manipulating said at least one procedure element via said second section of said graphical user interface.

14. The system of claim 8 wherein said data-processing apparatus and said module are further operable in combination with one another to render media associated with said procedure, in response to manipulating said at least one procedure element via said second section of said graphical user interface.

15. A program product residing in a computer for graphically developing a procedure, comprising:
instruction media residing in a computer for displaying a plurality of procedure elements in a first section of a graphical user interface; and
instruction media residing in a computer for selecting at least one procedure element among said plurality of procedure elements for manipulation in a second section of said graphical user interface in order to modularize said plurality of procedure elements, in response to a user selection of said at least one procedure element via said graphical user interface; and
instruction media residing in a computer for creating a procedure by manipulating said at least one procedure element via said second section of said graphical user interface, thereby promoting a consistency in the configuration, development and modification of said procedure.

16. The program of claim 15 further comprising instruction media residing in a computer for graphically dragging said at least one procedure element from said first section to said second section of said graphical user interface, in response to selecting said at least one procedure element among said plurality of procedure elements.

17. The program product of claim 15 further comprising instruction media residing in a computer for generating sequencing data associated with said procedure by manipulating said at least one procedure element via said second section of said graphical user interface.

18. The program product of claim 15 further comprising instruction media residing in a computer for generating dependency data associated with said procedure by manipulating said at least one procedure element via said second section of said graphical user interface.

19. The program product of claim 15 further comprising instruction media residing in a computer for generating timing data associated with said procedure by manipulating said at least one procedure element via said second section of said graphical user interface.

20. The program product of claim 15 further comprising instruction media residing in a computer for generating analysis data associated with said procedure by manipulating said at least one procedure element via said second section of said graphical user interface.
